(19) United States
(12) Patent Application Publication
(10) Pub. No.: US 2007/0018417 A1
(43) Pub. Date: Jan. 25, 2007

(54) Portable door holder

(76) Inventor: Felix Ponce, Reseda, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/446,541

(22) Filed: Jun. 5, 2006

Related U.S. Application Data
(60) Provisional application No. 60/702,369, filed on Jul. 25, 2005.

(51) Int. Cl. B62B 1/00; B60R 25/00; F16D 69/00; B62B 5/00

(52) U.S. Cl. 280/79.7; 188/265; 70/226; 269/905

(57) ABSTRACT

Improvements in a mechanism configured to support a door when work is to be performed using movable clamp halves to clamp and hold a door. A movable ledge receives a door where the weight moves the ledge gravitationally downward to clamp the work piece. A fixed ledge is positioned in the path of movement of the door and the movable ledge to limit the movement and any excessive pressure which otherwise might be exerted on the door by the clamp halves. The clamp is mounted on a base which comprises angled piping to form a two-dimensional support for the clamp and the door. The mechanism includes removable or changeable wheels to transport the mechanism with or without a door. Post and hole braking mechanism is engageable to stop movement of the mechanism. A leg is further extendable to support the mechanism in a three point configuration.

### CROSS REFERENCE TO RELATED APPLICATION

This application claims priority to provisional application 60/702,369 filed Jul. 25, 2005.

### FIELD OF THE INVENTION

The present invention relates to a door holder and, in particular, to a carpenter's aid for holding and transporting a door, and for enabling work to be carried out thereon

### BACKGROUND OF THE INVENTION

The invention entitled “Door Holder and Electrical Carpenter's Aid” and described patent, U.S. Pat. No. 4,799,658, of which the present invention is an improvement, describes a mechanism by which a door may be supported when work is to be performed thereon. Over a period of time that it has been used, it has been found difficult and, at times, tedious to move the door from one location to another. For example, it may be necessary to perform carpentry or other work on the door at one locale and then move it to another place, and/or to position it or raise it from one orientation to another. In addition, when transporting the door, for example by hand-carrying it, accidental mishandling may damage or otherwise harm it.

Many devices have been devised to address clamping a door when work is to be performed and may be grouped into three categories. The first is illustrated by U.S. Pat. Nos. 771,753, 849,354, 1,067,667 and 1,606,634, in which the door is simply clamped between a pair of jaws by moving them manually or with the aid of a screw mechanism into contact with the sides of the door followed by, if necessary, use of wing nuts to affix them in position.

The second category is represented by U.S. Pat. Nos. 611,340, 848,837, 1,042,232, 1,138,088, 2,605,795 and 2,830,632, where the weight of the door brings the jaws into clamping contact with the sides of the door.

The third category includes U.S. Pat. Nos. 708,238 and 4,391,437, which employ a hook or a lever to close the jaws on the door. All these devices have one or more of the following shortcomings. Some require considerable manual effort in the clamping or unclamping operations. Others comprise a complex number of constituent parts which may be subject to malfunction or breakage, for example, by the weight of the work piece. In some cases, its weight might cause it to be jammed between the jaws and thereby to cause excessive squeezing of or injury to the door and possible indenting or marring of its sides and to prevent its facile removal from the device. Still others need to be supported on a substantially flat surface as a condition for enabling their operability.

### BRIEF SUMMARY OF THE INVENTION

These and other problems are successfully addressed and overcome by the present invention by providing mechanisms for transporting a door from one location to another and for supporting it in different positions. Briefly, wheels are secured to a frame member akin to the construction described in above-referenced U.S. Pat. No. 4,799,658 and a lifting mechanism is added to one end of a frame member that extends at right angles to the wheel frame member. A support for the door is appended at the other end of the frame member that supports the lifting mechanism. Thus, the door-so carried not only can be lifted or balanced at different angles but also prevented from turning or swiveling one the wheeled holder.

Several advantages are afforded by the improved construction. Movement of a door between locations is easily effected. The door is protected from harm or damage. The door can be tilted according to need.

Other aims and advantages, as well as a more complete understanding of the present invention, will appear from the following explanation of exemplary embodiments and the accompanying drawings thereof.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a perspective view of an embodiment of the portable door holder with a door shown clamped within the holder.

FIG. 2 shows a top view of the portable door holder with a wheel shown as phantom to show the braking mechanism.

FIG. 3 shows a cross sectional view of the portable door holder from FIG. 2.

### DETAILED DESCRIPTION

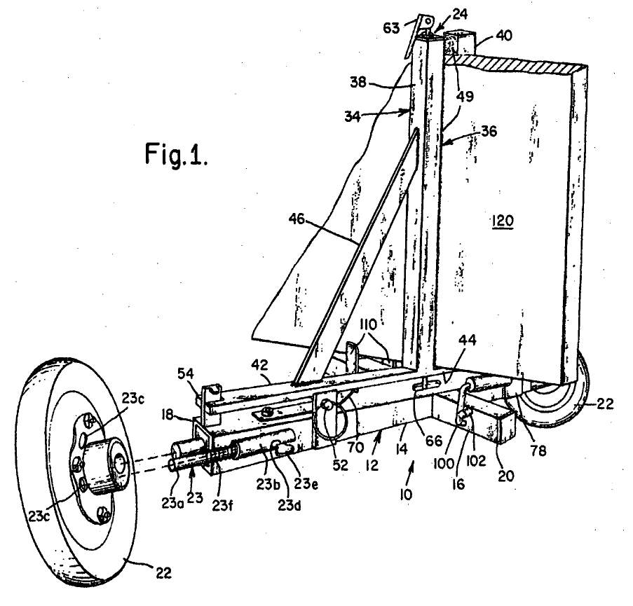

Accordingly, as depicted in FIGS. 1-3, a portable door holder 10 includes a base 12 comprising a pair of orthogonally disposed bars 14 and 16, respectively terminated at ends 18 and 20. A pair of wheels 22 is secured to the opposed ends 18 of the base. A door-embracing clamp 24 is secured to bar 14 intermediate its ends 18. Bars 14 and 16 may be formed, for example, from at least two tubes or pipes integrally secured together, to form the perpendicularly crossed configuration. The crossed bars are in the same general plane and thereby provide a two-dimensional support for clamp 24.

Wheels 22 are journalled onto the respective ends of base bar 14, and can be locked thereto by respective brakes 23, one of which is depicted in FIG. 1. The brake includes a brake lock pin 23a which is slidably housed within a housing 23b. Housing 23b is affixed to bar 14. Wheels 22 include several latching openings 23c for selective receipt of an end of lock pin 23a. The lock pin includes an abutment 23d generally midway between its ends and a thumbscrew 23e engagement at its end opposite the end disposed to engage one of wheel lock openings 23c. A spring 23f is positioned about pin 23a and between housing 23b and pin abutment 23d. Thus, spring 23f urges lock pin 23a into one of wheel openings 23c to lock the wheel from rotation. Thumbscrew 23e is used to withdraw the pin from engagement from the wheel.

Clamp 24 comprises halves 34 and 36, respectively including upstanding posts 38 and 40, legs 42 and 44 generally perpendicular to their respective posts, and braces 46 and 48 affixed to their posts and legs. Padding 49 of soft material is placed on all portions of the posts which come into contact with the door to protect its surfaces from scratches and other harm. A pivot 50 is secured to and extends above one end of base bar 14, and is coupled to leg 42 of clamp half 34 by a pin 52 so that clamp half 34 is rockable on the base. To ensure the greatest rigidity of clamp half 34 and to prevent bending of its leg 42, brace 46 is secured to leg 42 at a point above pivot pin 52. A pair of guiding hands 54 are secured to the base and form therewith a U-shaped bracket which extends on either side of leg 42 to prevent side-to-side movement of clamp half 34 with respect to base bar 14. A ledge 58 extends oppositely from the other end of leg 42 towards post 40 of clamp half 36, and projects beyond post 38 of clamp half 34. Ledge 58 is adapted to form a rest for a door as will be presently described and has a portion of padding 49 attached thereto. A latching rod 62 is housed within post 38, and has a latching finger 64 (see FIG. 3) which is extendable into bar 14 for engagement in a cooperating slot 66 therein. A pin-manipulating handle 63 at an end of rod 62 opposite from finger 64 is coupled to pin 62 for manipulation of latching finger 64 into and out of slot 66, thus to form respectively a secured and unsecured clamping of clamp half 38 to base 12.

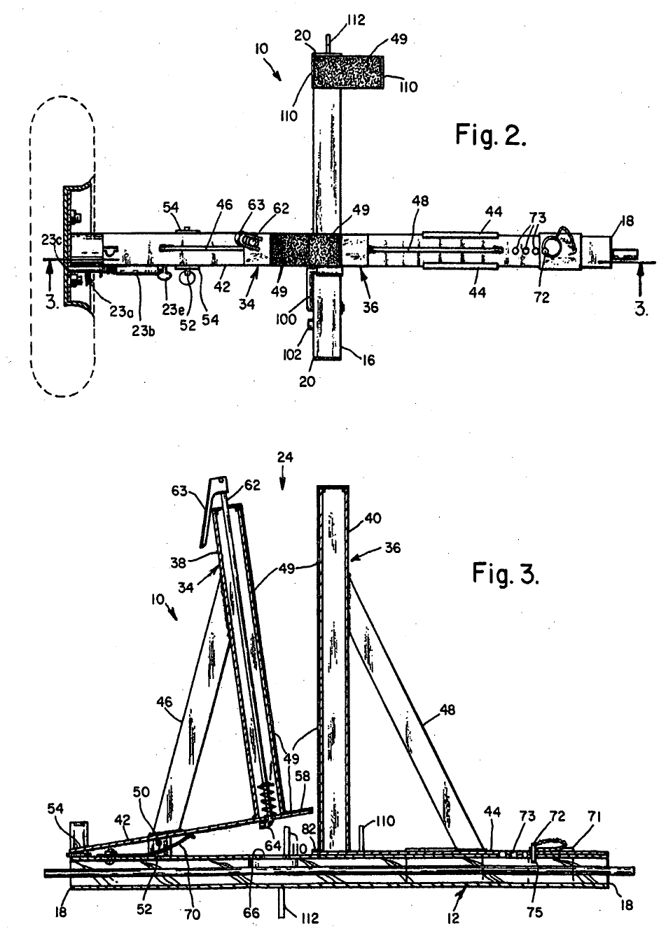

As best shown in FIGS. 2 and 3, leg 44 of clamp half 36 is in full sliding contact with bar 14, extends through a guide 71 on bar 14, and is adjustably secured thereto by a latching pin 72 beyond the guide. The adjustable securing comprises pin 72, which is selectively positionable in and engageable with one of holes 73 adjacent an end of leg 44 and is disposed to enter a hole 75 in bar 14. A pair of arms 78 (see FIGS. 1 and 2), affixed to bar 14 and straddling leg 44, have upper portions 80, which are bent over leg 44 to secure it in a slidable engagement with the base. A ledge 82 (see FIG. 3) with a further portion of padding 49 thereon is adjacent post 40 of clamp half 36 and provides a stop to the downward movement of a door.

As best shown in FIGS. 1 and 2, a door support 100 is pivotally secured adjacent one end 20 of base bar 16, and is disposed to lie flat on bar 16, as depicted in FIG. 2, or to be elevated, as illustrated in FIG. 1. In its elevated position, support 100 rests against a stop 102. A pair of upstanding guides 110 are placed at an end 20 opposite from that where support 100 is pivotally secured. Guides 110 are disposed to hold a door from swinging about base 12 and its bars 14 and 16. A leg 112 extends downwardly from bar 16, in a direction opposite from that of upstanding guides 110. When door holder 10 is at rest, leg 112 and wheels 22 for a triangular support for the door holder.

As illustrated in FIG. 1, a door 120 is placed within and held in holder 10. It may be supported to rest within upstanding guides 110 and on support 100 when the support is upwardly pivoted to rest against stop 102, as shown in FIG. 1. Alternately, when support 100 is pivoted otherwise against bar 16, as shown in FIG. 2, door 120 is permitted to be pivoted where it is raised from between upstanding guides 110.

The operation of clamp 24 is as follows. Clamp half 36 is adjusted with respect to its mating clamp half 38 by appropriate engagement of latching pin 72 in one of holes 76 and into bar hole 75, so that the spacing between the clamp halves approximates the thickness of door 120. The door is then placed within holder 10, between halves 34 and 36 and on ledge 58, so that its weight causes clamp half 34 to pivot about pin 52 and against the bias of spring 70. Gravitationally downward movement of the door and the pivoting of clamp half 34 is arrested by contact with stop ledge 82, at which point posts 38 and 40 grip the sides of the door but without excessive force because ledge 82 prevents over-travel of clamp half and its post 38 with respect to mating clamp half 40 and its post 40, and the preset adjustment of clamp half 36 with respect to base 14. Carpentry work is then performed, including the use of any electrically-powered tools. After completion of the work, the door is easily removed from aid 10 or, moved from one location to another, as aided by wheels 22.

Although the invention has been described with respect to a particular embodiment thereof, it should be realized that various changes and modifications may be made therein without departing from the spirit and scope of the invention.

Thus, specific embodiments of a portable door holder have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A holder for uprightly supporting an item, having large area sides and a relatively small thickness between the sides, by a clamp supported on a base and having first and second surfaces spaced from one another to define an entry for reception of the item, means for defining a movable connection between said first and second surfaces to enable respective opening and closing movements therebetween, and means positioned in said entry and coupled to said first surface for receiving the item and for enabling its weight to move the receiving means in a generally gravitationally downward path and thereby to move said first surface towards and second surface and to clamp the item therebetween under increasing pressure thereon, the improvement comprising:
finite positioning of the first or second surface to provide fixed positioning of the first or second surface to accommodate the specific thickness of the item to be clamped.

2. The holder for upright supporting an item from claim 1 where the improvement further includes indicia to indicate the clamping thickness of the holder.

3. The holder for upright supporting an item from claim 1 where the improvement further includes finite positioning using a pin in a hole to maintain the position of the first or second surface.

4. The holder for upright supporting an item from claim 3 where the pin is secured to the holder using a chain, cable or spring.

5. The holder for upright supporting an item from claim 1 where the improvement further includes finite positioning utilizing a spring loaded pin to maintain the position of the first or second surface.

6. The holder for upright supporting an item from claim 1 where the improvement further includes wheels on the holder for wheeled transportation of the holder.

7. A holder for uprightly supporting an item, having large area sides and a relatively small thickness between the sides, by a clamp supported on a base and having first and second surfaces spaced from one another to define an entry for reception of the item, means for defining a movable connection between said first and second surfaces to enable respective opening and closing movements therebetween, and means positioned in said entry and coupled to said first surface for receiving the item and for enabling its weight to move the receiving means in a generally gravitationally downward path and thereby to move said first surface towards and second surface and to clamp the item therebetween under increasing pressure thereon, the improvement comprising:
a braking system utilizing an extendable member that is engageable into a depression in a hub of a wheel.

8. The holder for upright supporting an item from claim 7 where the extendable member further includes a spring to maintain the extendable member in an engaged configuration.

9. The holder for upright supporting an item from claim 7 where the extendable member is maintained in position with a spring.

10. The holder for upright supporting an item from claim 7 where the extendable member can be maintained in position with a threaded fastener.

11. The holder for upright supporting an item from claim 10 where the threaded fastener is a thumbscrew.

12. The holder for upright supporting an item from claim 7 where the depression comprises multiple depressions or holes.

13. A holder for uprightly supporting an item, having large area sides and a relatively small thickness between the sides, by a clamp supported on a base and having first and second surfaces spaced from one another to define an entry for reception of the item, means for defining a movable connection between said first and second surfaces to enable respective opening and closing movements therebetween, and means positioned in said entry and coupled to said first surface for receiving the item and for enabling its weight to move the receiving means in a generally gravitationally downward path and thereby to move said first surface towards and second surface and to clamp the item therebetween under increasing pressure thereon, the improvement comprising:
wheels that are removable and or changeable to accommodate movement of the holder over various surfaces.

14. The holder for upright supporting an item from claim 13 where wheels of different diameters can be interchanged on the holder.

15. The holder for upright supporting an item from claim 13 where the wheels further include braking means to prevent rotation of the wheels.

16. The holder for upright supporting an item from claim 13 whereby when the wheels are removed, the base of the holder provides a flat surface to maintain the clamped item in a vertical orientation.

17. The holder for upright supporting an item from claim 13 whereby the wheels are maintained on the holder with at least one threaded fastener, cotter pin, speed nut or interference fit.

18. The holder for upright supporting an item from claim 13 wherein the wheels are smooth to accommodate flat surfaces or rough to accommodate uneven surfaces.

19. Improvements in a mechanism configured to support a door when work is to be performed using movable clamp halves to clamp and hold a door. A movable ledge receives a door where the weight moves the ledge gravitationally downward to clamp the work piece. A fixed ledge is positioned in the path of movement of the door and the movable ledge to limit the movement and any excessive pressure which otherwise might be exerted on the door by the clamp halves. The clamp is mounted on a base which comprises angled piping to form a two-dimensional support for the clamp and the door. The mechanism includes removable or changeable wheels to transport the mechanism with or without a door. Post and hole braking mechanism is engageable to stop movement of the mechanism. A leg is further extendable to support the mechanism in a three point configuration.
